(19) United States
(12) Patent Application Publication
(10) Pub. No.: US 2019/0191632 A1
(43) Pub. Date: Jun. 27, 2019

(54) PLANT PHENOTYPING TECHNIQUES USING OPTICAL MEASUREMENTS, AND ASSOCIATED SYSTEMS AND METHODS

(71) Applicant: X Development LLC, Mountain View, CA (US)

(72) Inventors: William Regan, San Carlos, CA (US); Benoit Schillings, Los Altos Hills, CA (US); David Brown, San Francisco, CA (US); Matthew Bitterman, Mountain View, CA (US)

(21) Appl. No.: 15/855,955

(22) Filed: Dec. 27, 2017

(51) Int. Cl. A01G 7/00; G06T 7/00

(52) U.S. Cl. CPC A01G 7/00; G06T 7/0004; G06T 2207/10036; G06T 2207/10048; B64C 39/024; G06T 2207/30128; G06T 2207/30188; G06T 2207/10116; G06T 2207/10132

(57) ABSTRACT

Systems and methods for plant phenotyping using mechanical manipulation are disclosed. In one embodiment, a method for plant phenotyping includes: acquiring a first image of a plant with a first imaging modality operating in a first spectrum; and acquiring a second image of the plant with a second imaging modality operating in a second spectrum. The first spectrum and the second spectrum have different depths of penetration through the plant. The method also includes analyzing the first image and the second image to determine the properties of the plant.

### CROSS REFERENCE TO RELATED APPLICATIONS

The present application is related to a U.S. application entitled “Improved Plant Phenotyping Techniques Using Mechanical Manipulation, and Associated Systems and Methods,” Attorney Docket Number XCOM164869, filed on the same day.

### BACKGROUND

Plants are periodically evaluated in-field to estimate their size, stage of growth, sufficiency of watering, size of fruit, presence/absence of pests or disease, or other observable traits or characteristics. Such evaluation of plants is referred to as phenotyping.

FIG. 1A is a picture of plants obtained in accordance with conventional technology. With some conventional technologies, the in-field phenotyping involves acquiring optical images of plants. These images are subsequently analyzed to establish relevant properties of the plants, for example, size of the plant, size of the fruit, etc. In many applications, the subsequent treatment of the plants (e.g., watering, application of pesticides, harvesting, etc.) is decided based on the analysis of the images. However, conventional imaging generates a large volume of relatively incomplete or difficult-to-analyze data. For example, parts of plants may be occluded or obscured such that relevant plant properties are difficult to derive from the images. Therefore, trained operators sometimes physically separate (physically “segment”) a plant 10 from the rest of the plants to make the outline of the plant 10 sharper and, thus, more suitable for subsequent analysis of the acquired image. However, such an individualized treatment of the target plant increases the cost and time of the in-field phenotyping.

FIG. 1B is a picture of the plant 10 obtained in accordance with conventional technology. With the illustrated conventional technology, a physical backdrop 12 is placed behind the plant 10 to improve the isolation/contrast of the plant 10 against other plants in the field, therefore improving the sharpness of the image. As a result, the analysis of the image of the plant 10 is more accurate. However, placement of physical backdrops increases the time required for acquiring images and the cost of the phenotyping.

FIG. 1C is a graph of plant phenotyping results obtained with conventional technology. With some conventional technologies, the internal or otherwise occluded plant features can be exposed by operators prior to imaging these plant features. For example, the operator may remove the husk that hides the corn ear structure prior to imaging corn kernels 14. Once a relatively sharp outline of the corn kernels 14 is imaged, the size of the corn kernels may be obtained by fitting a suitable periodic curve 16 having amplitude and period that approximates the size of the corn kernels. Next, the curves 16 can be represented as a frequency-amplitude graph 17. In the illustrated example, one or more peaks in the graph 17 correspond to the average length of the corn kernels 14. However, this conventional technology results in a physical destruction of the corn ear structure that is evaluated.

FIG. 1D is a picture of a field phenotyping system in accordance with conventional technology. An enclosure 25 carries a camera, while also limiting the amount of stray light around the plants. As a result, the images obtained by the camera are subjected to a more uniform intensity of light, which, in turn, makes subsequent analysis of the images more consistent. In operation, a tractor 20 pulls the enclosure 25 while the camera captures the images. However, this conventional technology requires additional equipment, namely, physical enclosures which must scale up in size as the plant grows, therefore increasing the cost of the phenotyping.

Accordingly, there remains a need for in-field plant phenotyping techniques and systems having a high-throughput and low cost of acquiring images that can be analyzed to produce accurate data about plants.

### DESCRIPTION OF THE DRAWINGS

The foregoing aspects and many of the attendant advantages of the inventive technology will become more readily appreciated as the same become better understood by reference to the following detailed description, when taken in conjunction with the accompanying drawings, wherein:

FIG. 1A is a picture of a plant obtained in accordance with conventional technology;

FIG. 1B is a picture of a plant obtained in accordance with conventional technology;

FIG. 1C is a graph of plant phenotyping results obtained with conventional technology;

FIG. 1D is a picture of a field phenotyping system in accordance with conventional technology;

FIG. 2 is a schematic view of a phenotyping system in accordance with embodiments of the present technology;

FIG. 3 is a schematic view of a phenotyping system in accordance with embodiments of the present technology;

FIG. 4 is a graph of the solar spectrum;

FIG. 5 is a schematic view of a phenotyping system operating in the H-α frequency band in accordance with embodiments of the present technology;

FIG. 6 is a schematic diagram of a trait extraction model in accordance with an embodiment of the present technology;

FIG. 7 is a schematic view of an analysis system in accordance with an embodiment of the present technology;

FIG. 8 is a flow diagram of a method for plant phenotyping in accordance with an embodiment of the present technology; and

FIGS. 9A and 9B are graphs of plant detection in accordance with an embodiment of the present technology.

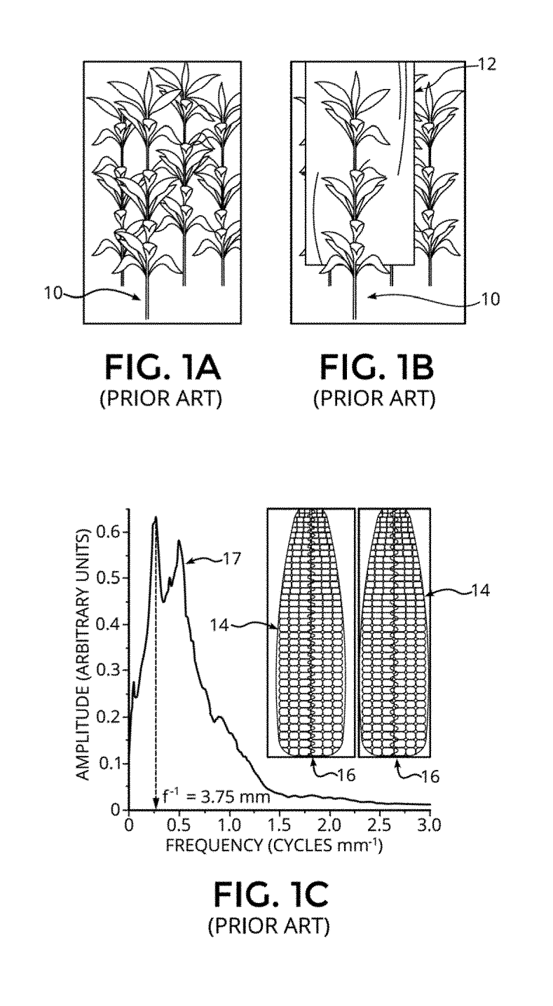

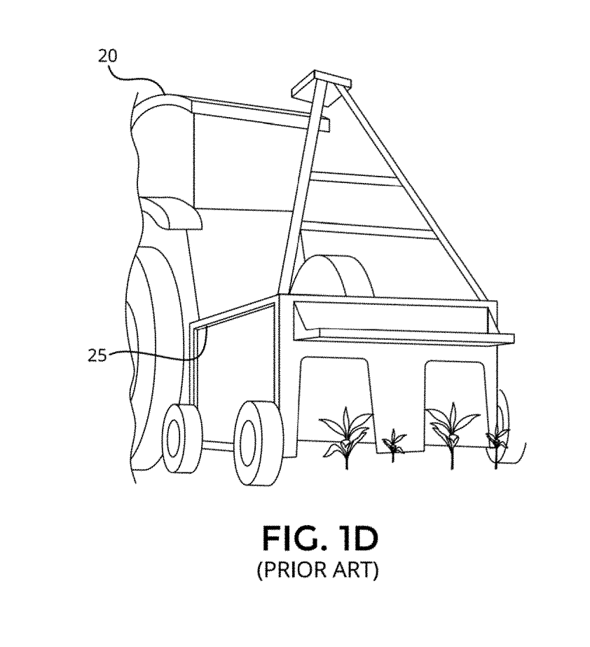

### DETAILED DESCRIPTION

While illustrative embodiments have been described, it will be appreciated that various changes can be made therein without departing from the spirit and scope of the inventive technology. Embodiments of the inventive technology are generally applicable to the in-field, non-destructive phenotyping measurements of internal or occluded plant features, for example, size, stage of growth, sufficiency of watering, presence/absence of pests or disease, etc.

In some embodiments, multiple imaging modalities are used to acquire images of the plant(s) of interest to improve the accuracy and/or speed of the subsequent analysis of plant features (also referred to as “plant attributes”). Some examples of imaging modalities are camera sensors that operate within a frequency bandwidth (e.g., visible light, infrared light, X-rays, etc.), camera lenses that have different focal depths, optical or electromagnetic filters that transmit within a certain bandwidth while rejecting radiation outside of the bandwidth, and cameras that have different resolutions of the sensor. For example, one imaging modality may operate in the visible spectrum while another imagined modality operates in the X-ray spectrum. The imaging modality that operates in the visible spectrum may provide information about the size of the plant, color of the leaves, size of the fruit, etc., but the plant features that are occluded by proximate plants are not in the image, and, therefore, not available for analysis. On the other hand, the imaging modality that operates in the X-ray spectrum may not acquire very precise images about, for example, the outline of the plant, but the acquired images may reveal the occluded portions of the plant. In many embodiments, when the images obtained by different imaging modalities are analyzed as a group, relevant attributes of the plant can be defined more accurately.

In some embodiments, the system includes one or more dedicated sources that provide required electromagnetic or ultrasonic spectrum for the camera(s). For example, the system may include a source of ultrasound and an ultrasound camera (also referred to as a “receiver” or a “sensor” or “an ultrasound imaging modality”) for capturing the reflected ultrasound. Analogous pairs of source/imaging modality may operate in other spectra, for example, mm wave, X-ray, etc. In some embodiments, the imaging modalities, the sources, and/or analysis system may be carried by a ground vehicle or an air vehicle. In some embodiments, the vehicles may be unmanned.

In some embodiments, a source of mm-wave or microwave may heat the target plant. Generally, heating of the plant is a function of the properties of the plant, for example, size of the fruit, fraction of water in the plant, etc. Therefore, in some embodiments, the properties of the plant can be derived by analyzing images of the heated plants that were obtained in the infrared spectrum.

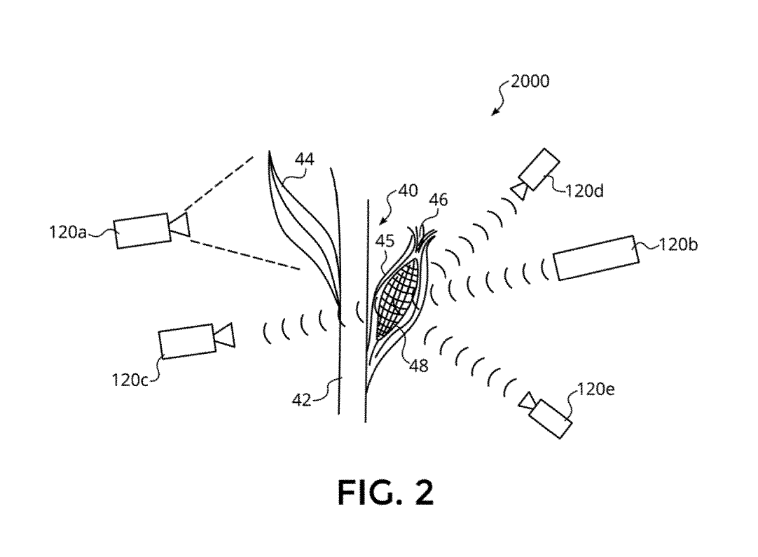

FIG. 2 is a schematic view of a phenotyping system 2000 in accordance with embodiments of the present technology. In some embodiments, the system 2000 includes several imaging modalities and sources that can operate either sequentially or simultaneously. The images acquired by the imaging modalities capture relevant features of the plant 40 (e.g., a stalk 42, a husk 45, a flower 46, a corncob 48, etc.). The images may be temporarily stored on the camera or forwarded to an analysis system for analyzing the images. The images can be indexed based on, for example, time of the image acquisition, properties of the imaging modality, for example, location, spectrum of operation, angle of view, direction, and other properties of the imaging modality. In some embodiments, the indexing may be based on determining that the first image and the second image include the same plant.

In some embodiments, the system 2000 may include a camera 120a configured to work in the visible spectrum. In some embodiments, the system 2000 includes pairs of sources and imaging modalities. For example, an X-ray source 120b may emit X-rays through the plant 40 toward an imaging modality 120c (e.g., an X-ray receiver or sensor). Furthermore, a source of ultrasound 120e may emit ultrasound that reflects off the plant 40 toward the imaging modality 120d (e.g., an ultrasound receiver or sensor). In at least some applications, the ultrasound penetrates internal features of the plant 40 before reflecting toward the imaging modality 120d. Therefore, the images acquired by the imaging modality 120d may include plant features that are normally occluded, for example the features of the corncob hidden by the husk. Analogously, the images based on the X-rays or other electromagnetic spectra may capture features of the plant that are normally not available or not clearly outlined in the visible light spectrum. When analyzed as a group, the images acquired by different types of imaging modalities facilitate more precise and/or faster phenotyping of the plant. Such analysis of a group of images is sometimes referred to as sensor fusion for co-analyzing data from multiple sensors.

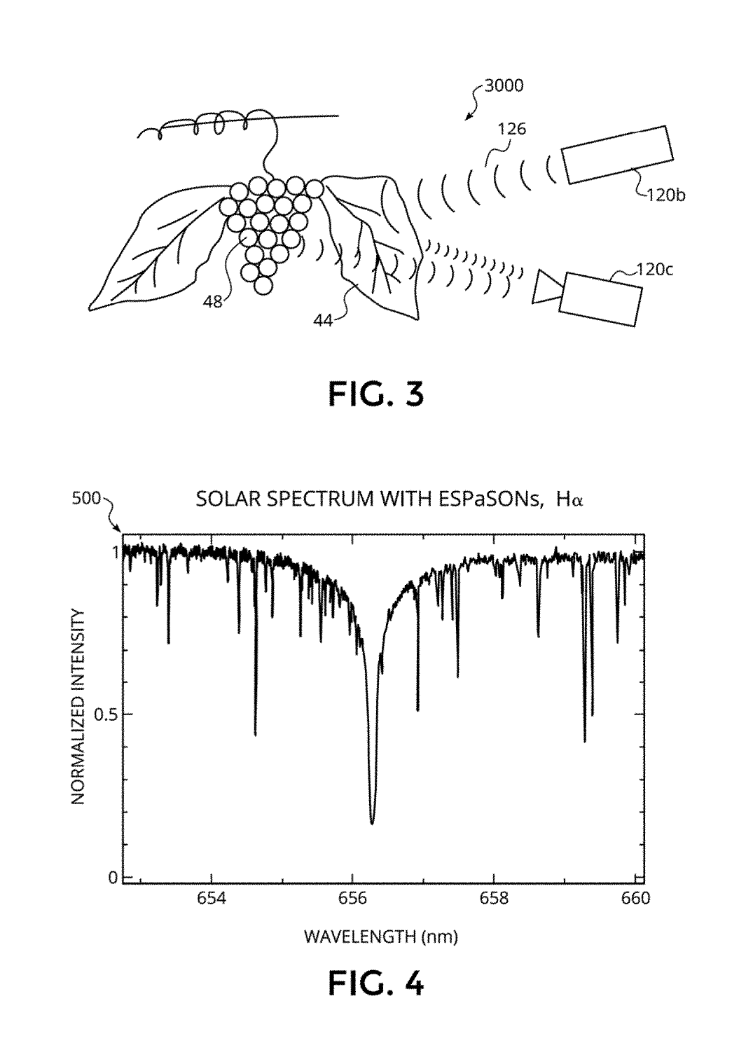

FIG. 3 is a schematic view of a phenotyping system 3000 in accordance with embodiments of the present technology. In some embodiments, the system includes a source of radiation (e.g., a source of electromagnetic waves) 120b, and an imaging modality 120c. For example, the source 120b may operate in the mm-wave or the microwave spectrum (i.e., the wavelength ranges from about 1 mm to about 30 cm), and the imaging modality 120c may operate in the infrared spectrum. In operation, the fruit 48 and the leaf 44 absorb the radiation from the source 120b, resulting in a temperature increase. However, since the thermal mass of the fruit 48 is typically higher than that of the leaf 44, the temperature rise of the fruit 48 and the leaf 44 above the ambient temperature are also typically different. Therefore, the images of these different parts of the plant are registered differently by the infrared imaging modality 120c. Analogously, other parts of plants, for example, stalk, branches, flower, etc., that are illuminated by the source 120b also look different in the images acquired by the infrared imaging modality 120c, depending on the thermal mass of the parts of plants. In some embodiments, based on the images acquired by the imaging modality 120c, the analysis system can determine, for example, the mass, water content, size, ripeness, and other properties of the plant or parts of the plant.

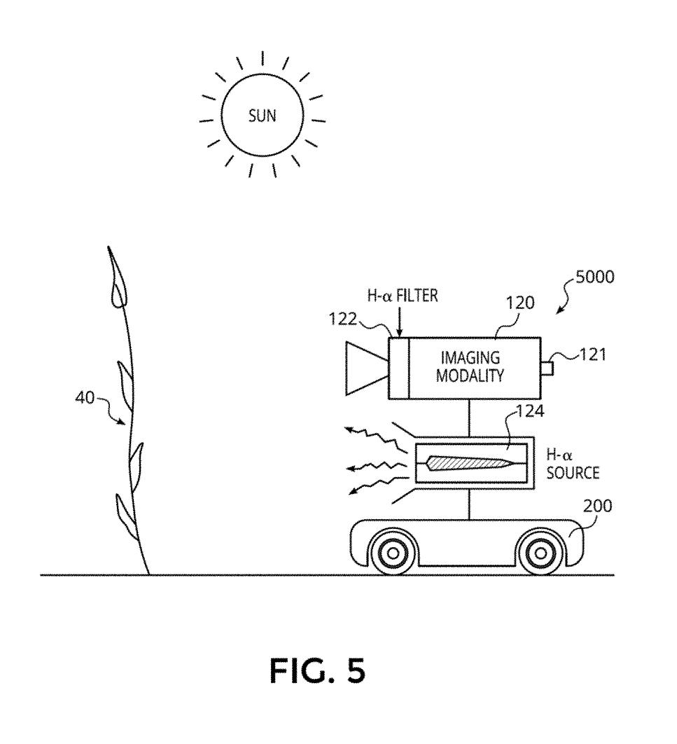

FIG. 4 is a graph of the solar spectrum. The horizontal axis represents a subset of visible wavelengths from about 653 nm to about 660 nm. The vertical axis represents a normalized intensity of the solar light. The illustrated subset of the solar spectrum includes several dips in the light intensity. For example, for the wavelength of 656.28 nm (also referred to as the H-α wavelength or, in the context of frequencies, the H-α frequency), the normalized intensity of light drops to about 20% of the normalized light intensity in the shown range of the wavelengths. Other dips in the intensity of solar radiation exist. Some embodiments of the inventive technology that use the H-α wavelength or other relatively weakly-represented wavelengths are described with reference to FIG. 5 below.

FIG. 5 is a schematic view of a phenotyping system 5000 operating in the H-α frequency band in accordance with embodiments of the present technology. In some embodiments, the phenotyping system 5000 includes an unmanned ground vehicle (UGV) 200 that carries the imaging modality 120 and a source of light 124 that emits light at the H-α wavelength. Some sources of light at the H-α wavelength are hydrogen discharge tubes, semiconductor lasers, light emitting diodes, and other sources. The imaging modality 120 may include a bandpass filter that is centered at around H-α wavelength to selectively allow H-α wavelengths toward the imaging modality. The illustrated system 5000 shows the UGV 200, however, in other embodiments a manned vehicle or an unmanned aerial vehicle (UAV) may be used. The UGV 200 may carry a GPS (not shown). In some embodiments, the UGV may traverse the field with the plants 40 to obtain images that correspond to, for example, average properties of the plants in the field.

Since the solar emission at the H-α wavelength is generally weak, in many in-field situations the emission of the source 124 at the H-α wavelength is stronger than the H-α emission by the Sun. As a result, in some embodiments, the illustrated imaging modality 120 receives the H-α emission that is relatively independent or weakly dependent on the solar H-α emission. Therefore, the imaging modality 120 may acquire plant images of comparable intensity, for example, during day or night, in sunny or cloudy weather, etc. In some embodiments, a more uniform intensity of light results promotes a more accurate analysis of the plant attributes (properties). In some embodiments, the relative uniformity of the light generated by the source 124 provides a reference point that improves the calibration of the solar spectrum in the field. For example, the relatively small amount of transmitted solar H-alpha light may allow calibration of the current incident sunlight intensity, which is useful for understanding how much light the plants are receiving at the moment.

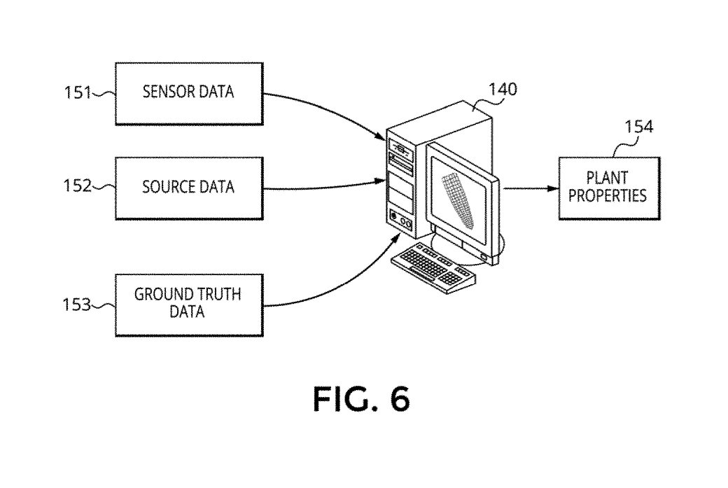

FIG. 6 is a schematic diagram of a trait extraction model in accordance with an embodiment of the present technology. In the illustrated embodiment, an analysis system 140 receives data 151 from one or more imaging modalities 151. Furthermore, the analysis system may receive source data 152 from, for example, a source of ultrasound, a source of H-α light, a source of X-rays, etc. Some examples of the source data 152 are the intensity of the source, the angle of the source with respect to the plant of interest, the frequencies of emission of the source, etc. In some embodiments, the analysis system 140 receives ground truth data, for example, images of exposed corn ear, physical measurements of the stalk, observations about presence or absence of pests, etc.

The analysis system 140 includes software and instructions for analyzing images. In operation, the analysis system 140 processes the inputs using, for example, algorithms for digital image recognition. Based on the processing of the inputs 151-153, the analysis system 140 evaluates plant properties 154, for example, ripeness of the fruit, size and strength of stalk, water content of the leaves, etc. In some embodiments, the analysis system 140 is trainable to improve the evaluation of plant properties based on past analysis.

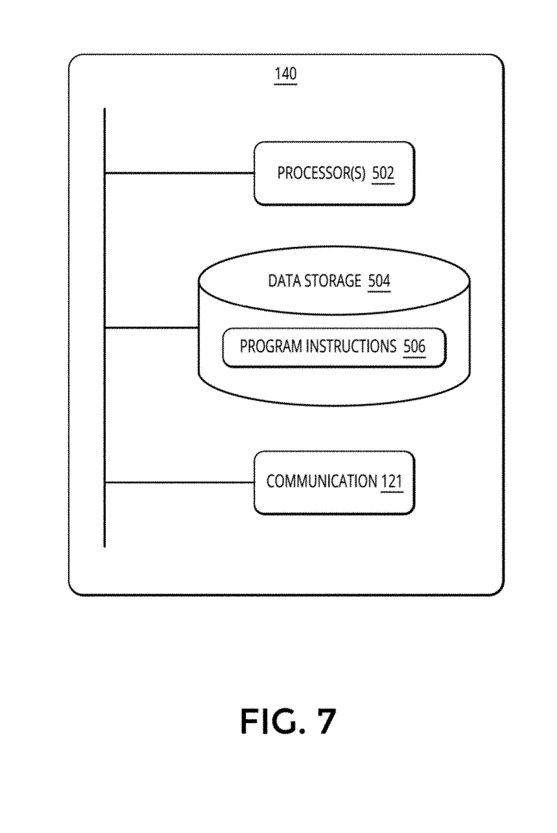

FIG. 7 is a schematic view of an analysis system in accordance with an embodiment of the present technology. In some embodiments, the analysis system 140 includes one or more processors 502 and a data storage 504, such as a non-transitory computer readable medium. The data storage 504 may store program instructions 506, which may be executable by the processor(s) 502. The analysis system 140 may include the communication interface 121 for communication with the imaging modality. In different embodiments, the various components of the analysis system 140 may be arranged and connected in a different manner.

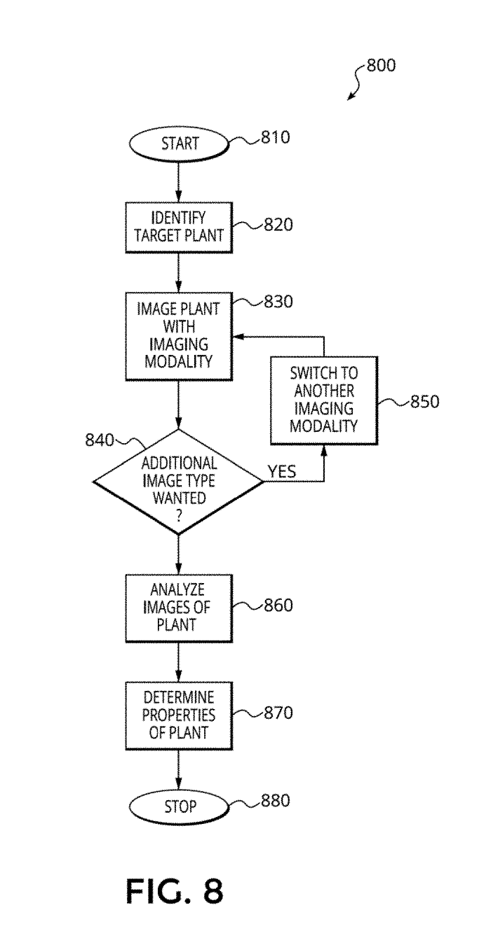

FIG. 8 is a flow diagram of a method 800 for plant phenotyping in accordance with an embodiment of the present technology. In some embodiments, the method may include additional steps or may be practiced without all steps illustrated in the flow chart. Furthermore, in some embodiments, the order of the steps may be changed.

The method starts in block 810, and continues to block 820. In block 820, a target plant is identified for image acquisition. In some embodiments, a particular part of the plant, for example, the stalk or the fruit, is targeted for image acquisition.

In block 830, the imaging modality acquires one or more images of the plant. The imaging modality may operate in a visible spectrum, in an X-ray spectrum, in the ultrasound spectrum, etc. In some embodiments, the system includes a source of ultrasound or electromagnetic radiation (e.g., X-rays, H-α spectrum, etc.). In some embodiments, a vehicle (e.g., UAV or UGV) carries the imaging modalities and the sources.

In block 840, a decision is made whether to use an additional imaging modality. If the additional imaging modality is to be used, the method switches to that imaging modality in block 850, and the additional images are acquired in block 830. Switching between different imaging modalities may include adjusting camera settings, switching camera lenses, switching lens filters, switching illuminators, or switching between different physical camera types. If no additional imaging modality is to be used, the method proceeds to block 860 to analyze the images of plants. In some embodiments, the inputs to the analysis system include the ground truth data and/or the source data.

In block 870, the analysis system determines the properties (attributes) of the plant. Some properties of the plant are size of the fruit, amount of water in the plant, etc. The method ends in block 880.

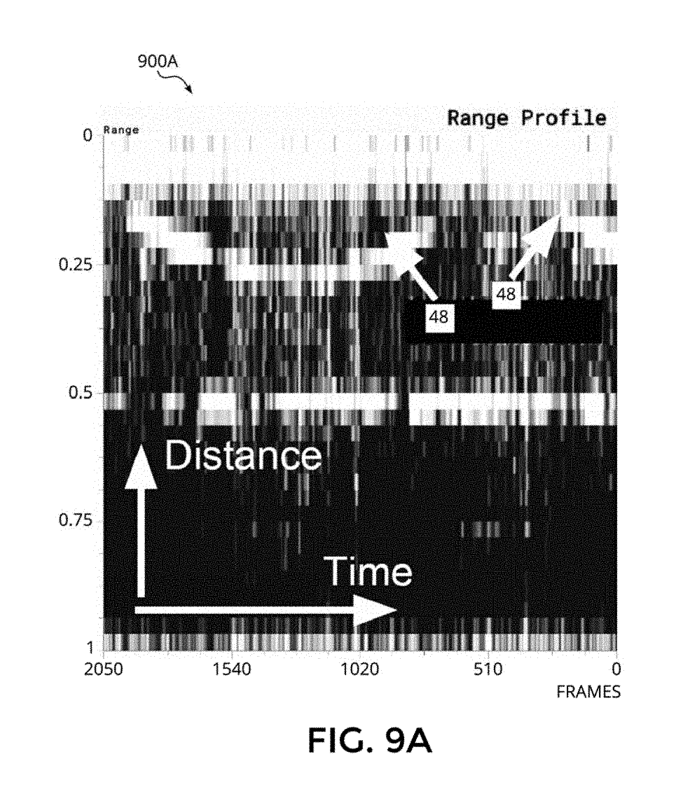

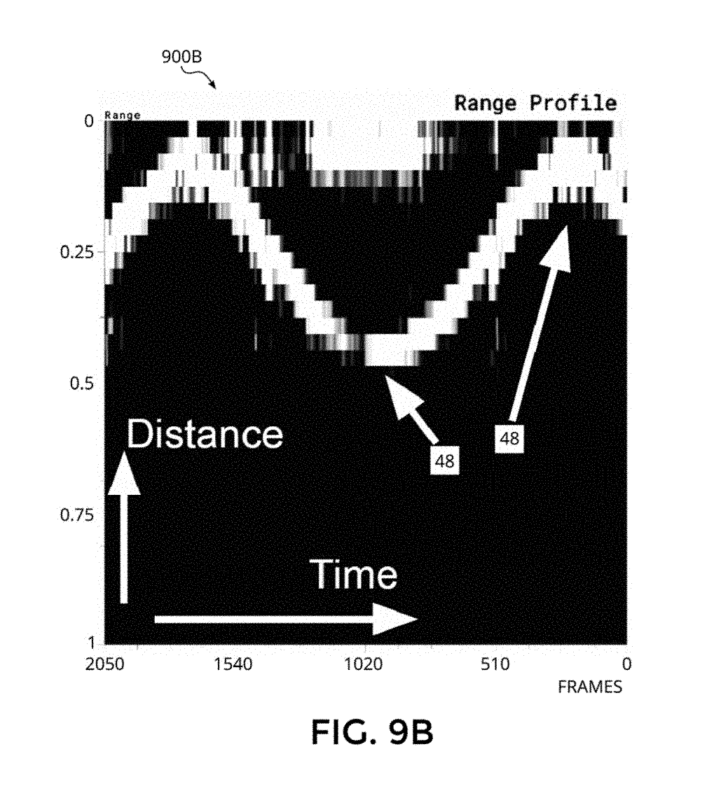

FIGS. 9A and 9B are graphs 900A and 900B of plant detection in accordance with an embodiment of the present technology. In both graphs, the horizontal axes correspond to time of frame acquisition. The vertical axes correspond to a distance that represents the presence of the target, which, in the illustrated case, is a strawberry fruit 48. In some embodiments, a time series of images of the plant are acquired. The arrows point to the locations of the target fruit. In practical in-field situations, parts of the plant may be occluded by other parts of the same plant or by other plants, therefore impeding optical access to the object of interest. For example, the fruit 48 of the plant may be occluded by the leaves of the surrounding plants. The graph 900A in FIG. 9A was obtained while the target fruit was occluded with one leaf, and the graph 900B in FIG. 9B was obtained while the target fruit was occluded with six layers of leaves. In both cases, a radar signal is able to penetrate the leaf canopy and reflect a measurable signature of the strawberry fruit, therefore enabling identification of occluded fruit.

Many embodiments of the technology described above may take the form of computer-executable or controller-executable instructions, including routines stored on non-transitory memory and executed by a programmable computer or controller. Those skilled in the relevant art will appreciate that the technology can be practiced on computer/controller systems other than those shown and described above. The technology can be embodied in a special-purpose computer, application specific integrated circuit (ASIC), controller or data processor that is specifically programmed, configured or constructed to perform one or more of the computer-executable instructions described above. In many embodiments, any logic or algorithm described herein can be implemented in software or hardware, or a combination of software and hardware.

From the foregoing, it will be appreciated that specific embodiments of the technology have been described herein for purposes of illustration, but that various modifications may be made without deviating from the disclosure. Moreover, while various advantages and features associated with certain embodiments have been described above in the context of those embodiments, other embodiments may also exhibit such advantages and/or features, and not all embodiments need necessarily exhibit such advantages and/or features to fall within the scope of the technology. Accordingly, the disclosure can encompass other embodiments not expressly shown or described herein.

1. A method for plant phenotyping, comprising:
acquiring a first image of a plant with a first imaging modality operating in a first spectrum, wherein the first spectrum is an H-α spectrum, and wherein the first imaging modality includes a band-pass filter centered about the H-α spectrum;
calibrating a second imaging modality based on an intensity of light in the H-α spectrum captured by the first imaging modality;
emitting microwaves by a source of microwaves;
heating the plant by the microwaves emitted by the source of microwaves;
acquiring a second image of the heated plant with the second imaging modality operating in a second spectrum that is an infrared spectrum, wherein the first spectrum and the second spectrum have different depths of penetration through the plant; and
differentiating different parts of the plant in the second image based on thermal masses of the different parts of the plant.

2. The method of claim 1, wherein at least one of the images is obtained through an occlusion of the plant.

3. The method of claim 1, wherein the first imaging modality and the second imaging modality operate simultaneously.

4. The method of claim 3, further comprising:
indexing the first image and the second image; and
based on indexing, determining that the first image and the second image include the same plant.

5. The method of claim 4, wherein the first imaging modality and the second imaging modality are carried by an unmanned ground vehicle (UGV) traversing a field, and wherein indexing corresponds at least in part to a location of the UGV.

6. The method of claim 5, wherein the location of the UGV is determined at least in part based on GPS signal.

7. The method of claim 5, further comprising determining average properties of plants in the field based at least in part on the location of the UGV.

8. The method of claim 4, wherein the first imaging modality and the second imaging modality are carried by an unmanned aerial vehicle (UAV) flying above a field, and wherein indexing corresponds at least in part to a location of the UAV.

9. (canceled)

10. The method of claim 9, wherein the first imaging modality is a camera acquiring images in the first spectrum, and the second imaging modality is the camera acquiring images in the second spectrum, and wherein a sensor of the camera is configured to acquire images in the first spectrum and the second spectrum.

11. The method of claim 9, wherein the first imaging modality correspond to a first camera acquiring images in the first spectrum, and the second imaging modality corresponds to a second camera acquiring images in the second spectrum.

12-14. (canceled)

15. The method of claim 1, further comprising emitting light in the H-α spectrum by a source of light.

16. (canceled)

17. The method of claim 1, further comprising:
emitting an ultrasound by a source of ultrasound; and
acquiring a reflected ultrasound by at least one of the first imaging modality and the second imaging modality.

18. The method of claim 1, further comprising:
acquiring a third image of a plant with a third imaging modality operating in a third spectrum; and
analyzing the third image to determine the properties of the plant.

19. A system for plant phenotyping, comprising:
a first imaging modality configured to acquire first images of a plant in a first spectrum;
a source of microwaves configured to emit microwaves that heat the plant;
a second imaging modality configured to acquire second images of the plant in a second spectrum, wherein the second spectrum is an infrared spectrum caused at least in part by the source of microwaves emitting the microwaves that heat the plant,
an image analysis system including a processor configured to differentiate properties of the plant in the second images, wherein the properties include thermal masses of different parts of the plant;
wherein the first spectrum and the second spectrum have different depths of penetration through a plant; and
a communication interface configured to transmit images from the first imaging modality and the second imaging modality to the image analysis system.

20. The system of claim 19, wherein the plant is a first plant, wherein the first plant is occluded by a second plant, and wherein at least at least one of the first imaging modality and the second imaging modality is configured to acquire images of the first plant through the second plant.

21. The system of claim 20, wherein the first spectrum is a visible light spectrum.

22. The system of claim 21, wherein the first spectrum is an X-ray spectrum.

23. The system of claim 19, further comprising an ultrasound transmitter configured to transmit ultrasound waves toward the plant, wherein at least one of the first imaging modality and the second imaging modality is responsive to the ultrasound waves reflected from the plant.

24. (canceled)

25. The system of claim 19, further comprising:
a GPS; and
an unmanned ground vehicle (UGV) configured to carry the first imaging modality, the second imaging modality, the communication interface, the GPS, and the image analysis system.

26. (canceled)

27. The system of claim 21, further comprising a source of an H-α spectrum configured to illuminate the plant, wherein the first imaging modality is configured to operate in the H-α spectrum, and wherein the first imaging modality includes a band-pass filter centered about an H-α spectrum.

28. The system of claim 21, wherein the first imaging modality comprises a first filter having a first bandpass, and the second imaging modality comprises a second filter having a second bandpass.

29. A system for plant phenotyping, comprising:
a first imaging modality configured to acquire images of a plant in a first spectrum, wherein the first spectrum is an H-α spectrum, and the first imaging modality includes a band-pass filter centered about the H-α spectrum;
a source of microwaves configured to emit microwaves that heat the plant;
a second imaging modality configured to acquire images of the plant in a second spectrum, wherein the second imaging modality is configured to operate in an infrared spectrum caused at least in part by the source of microwaves emitting the microwaves that heat the plant;
a communication interface configured to transmit images from the first imaging modality and the second imaging modality to an image analysis system; and
the image analysis system including a processor, wherein the image analysis system is configured to calibrate a second imaging modality based on an intensity of light in the H-α spectrum captured by the first imaging modality, and to differentiate the second images to determine thermal masses of different parts of the plant.
